(19) United States
(12) Patent Application Publication
(10) Pub. No.: US 2003/0231342 A1
(43) Pub. Date: Dec. 18, 2003

(54) Image formation system, image formation apparatus and image formation method

(76) Inventors: Takao Kurohata, Tokyo (JP); Yoshihisa Kamata, Tokyo (JP); Masahiro Osawa, Tokyo (JP)

Correspondence Address: Lisa A. Bongiovi, 55 Griffin South Road, Bloomfield, CT, 06002, US

(21) Appl. No.: 10/456,411

(22) Filed: Jun. 6, 2003

(30) Foreign Application Priority Data
Jun. 13, 2002 (JP) 2002-172282

(51) Int. Cl. B41B 1/00; B41F 1/00; G06F 15/00

(52) U.S. Cl. 358/1.15; 358/1.13

(57) ABSTRACT

An image formation system including a plurality of image formation apparatuses connected to a network that have at least one main image formation apparatus and one sub image formation apparatus. The main image formation apparatus has a receiving section for receiving print information from a connected external device; a judgment section for judging from the print information whether an assignment function for assigning printing to the main and sub image formation apparatuses is specified; a communication connection section for performing a communication connection processing with the sub image formation apparatus when the judgment section judges that the assignment function is specified; a print section for performing print operation in the main image formation apparatus according to the print information after the communication connection processing is performed; and a print information transfer section for transferring the print information to the sub image formation apparatus after the communication connection processing is performed.

### BACKGROUND OF THE INVENTION

1. Field of the Invention

The present invention relates to an image formation system comprising a plurality of image formation apparatuses, an image formation apparatus, and an image formation method.

2. Description of the Related Art

In an image formation system in which a plurality of image formation apparatuses such as printers and the like, are connected by a network, usually each image formation apparatus is managed by a print server (management server). A print server accepts a print request from a personal computer or the like on a network and controls print output to each image formation apparatus in response to this print request.

Recently, tandem printing in which image data read by a scanner in one image formation apparatus is printed in parallel with another image formation apparatus connected to the image formation apparatus by a network has been carried out. This will significantly shorten time required to perform a printing job, compared with a case where a printing job is performed with one image formation apparatus.

However, the above image formation system has produced the following problems.

In order to perform print output by the use of a management server in response to a print request from an external device, such as a personal computer or the like, on a network, all the image formation apparatus connected to the network is required to include a print controller for communicating with the external device. Thereby, there is a problem such that the cost becomes high. Moreover, installing a management server in an image formation system requires a person who manages the management server. Thereby, there is a problem such that personnel expenses increase.

### SUMMARY OF THE INVENTION

The present invention was made under the background circumstances as described above.

An object of the present invention is to realize tandem printing without installing a management server in an image formation system comprising a plurality of image formation apparatuses.

In order to solve the above-described problems, in accordance with a first aspect of the present invention, the image formation system comprises:

a plurality of image formation apparatuses connected to a network, the plurality of the image formation apparatuses having at least one main image formation apparatus and at least one sub image formation apparatus, and

the main image formation apparatus comprises:

a receiving section for receiving print information from a connected external device;

a judgment section for judging from the print information received by the receiving section whether or not an assignment function for assigning printing to the main image formation apparatus and the sub image formation apparatus is specified;

a communication connection section for performing a communication connection processing with the sub image formation apparatus when the judgment section judges that the assignment function is specified;

a print section for performing print operation in the main image formation apparatus according to the print information received by the receiving section after the communication connection processing by the communication connection section is performed; and

a print information transfer section for transferring the print information received by the receiving section to the sub image formation apparatus after the communication connection processing by the communication connection section is performed.

The main image formation apparatus may further comprise a release section for releasing the communication connection with the sub image formation apparatus when the communication connection with the sub image formation apparatus is incapable according to the communication connection processing by the communication connection section, and

the print section may begin the print operation according to the print information received by the receiving section after the release section releases the communication connection.

The main image formation apparatus may further comprise an assignment section for assigning copies to be printed to each of the main image formation apparatus and the sub image formation apparatus on the basis of the print information received by the receiving section when the communication connection with the sub image formation apparatus is capable according to the communication connection processing by the communication connection section, and

the print section may perform the print operation of the copies to be printed assigned to the main image formation apparatus by the assignment section.

The print information transfer section may transfer the print information again to the sub image formation apparatus when the main image formation apparatus receives notice from the sub image formation apparatus that the sub image formation apparatus is in an unprintable state.

The main image formation apparatus may further comprise a transfer section for transferring print data corresponding to the copies to be printed assigned to the sub image formation apparatus by the assignment section to the sub image formation apparatus on the basis of the print information received by the receiving section when the main image formation apparatus receives notice from the sub image formation apparatus that the sub image formation apparatus is in a printable state.

According to the first aspect of the present invention, the main image formation apparatus and the sub image formation apparatus are connected by the network and the main image formation apparatus controls printing divided between the main image formation apparatus and the sub image formation apparatus on the basis of the print information received from the external device. As a result, printing can be done in parallel by a plurality of image formation apparatuses without installing a management server.

Further, the main image formation apparatus may further comprise a release section for releasing the communication connection with the sub image formation apparatus when the print section completes the print operation of the copies to be printed assigned to the main image formation apparatus before the sub image formation apparatus goes into a printable state, and

the print section may begin the print operation of the copies to be printed assigned to the sub image formation apparatus after the release section releases the communication connection.

When the printing of the copies to be printed assigned to the main image formation apparatus is completed before the sub image formation apparatus goes into a printable state, the main image formation apparatus prints the copies to be printed assigned to the sub image formation apparatus. This enables efficient print output.

The print section in the main image formation apparatus may further perform the print operation of unprinted copies of the sub image formation apparatus when a situation under which the sub image formation apparatus is incapable of continuing the print operation has occurred during the print operation in the sub image formation apparatus.

Even if a situation under which the sub image formation apparatus cannot continue the print operation has occurred, the main image formation apparatus prints the unprinted copies of the sub image formation apparatus. This provides an operating environment which can flexibly cope with an abnormal situation.

The sub image formation apparatus may perform printing of unprinted copies of the main image formation apparatus when a situation under which the print section in the main image formation apparatus is incapable of performing the print operation has occurred.

When a situation under which the main image formation apparatus cannot perform the print operation has occurred, the sub image formation apparatus prints unprinted copies of the main image formation apparatus. This provides an operating environment which can flexibly cope with an abnormal situation.

In accordance with a second aspect of the present invention, the image formation system comprises:

a plurality of image formation apparatuses connected to a network, the plurality of the image formation apparatuses having at least one main image formation apparatus and at least one sub image formation apparatus, and

the main image formation apparatus comprises:

a receiving section for receiving print information from a connected external device; and

a print information transfer section for transferring the print information received by the receiving section to the sub image formation apparatus when printing by the sub image formation apparatus is specified in the print information.

According to the second aspect of the present invention, the main image formation apparatus connected to the external device has the function of transferring the print information to the sub image formation apparatus connected to the main image formation apparatus by the network. This increases the usefulness of the entire image formation system.

In accordance with a third aspect of the present invention, the image formation apparatus connected to an external device and connected to an external image formation apparatus by a network, comprises:

a receiving section for receiving print information from the external device;

a judgment section for judging from the print information received by the receiving section whether or not an assignment function for assigning printing to the image formation apparatus and the external image formation apparatus is specified;

a communication connection section for performing a communication connection processing with the external image formation apparatus when the judgment section judges that the assignment function is specified;

a print section for performing print operation according to the print information received by the receiving section after the communication connection processing by the communication connection section is performed; and

a print information transfer section for transferring the print information received by the receiving section to the external image formation apparatus after the communication connection processing by the communication connection section is performed.

The image formation apparatus may further comprise a release section for releasing the communication connection with the external image formation apparatus when the communication connection with the external image formation apparatus is incapable according to the communication connection processing by the communication connection section, and

the print section may begin the print operation according to the print information received by the receiving section after the release section releases the communication connection.

The image formation apparatus may further comprise an assignment section for assigning copies to be printed to each of the image formation apparatus and the external image formation apparatus on a basis of the print information received by the receiving section when the communication connection with the external image formation apparatus is capable according to the communication connection processing by the communication connection section, and

the print section may perform the print operation of the copies to be printed assigned to the image formation apparatus by the assignment section.

The print information transfer section may transfer the print information again to the external image formation apparatus when the image formation apparatus receives notice from the external image formation apparatus that the external image formation apparatus is in an unprintable state.

The image formation apparatus may further comprise a transfer section for transferring print data corresponding to the copies to be printed assigned to the external image formation apparatus by the assignment section to the external image formation apparatus on the basis of the print information received by the receiving section when the image formation apparatus receives notice from the external image formation apparatus that the external image formation apparatus is in a printable state.

According to the third aspect of the present invention, the image formation apparatus controls printing divided between the image formation apparatus and the external image formation apparatus on the basis of the print information received from the external device. As a result, printing can be done in parallel by a plurality of image formation apparatuses without installing a management server.

Further, the image formation apparatus may further comprise a release section for releasing the communication connection with the external image formation apparatus when the print section completes the print operation of the copies to be printed assigned to the image formation apparatus before the external image formation apparatus goes into a printable state, and

the print section may begin the print operation of the copies to be printed assigned to the external image formation apparatus after the release section releases the communication connection.

When the printing of the copies to be printed assigned to the image formation apparatus is completed before the external image formation apparatus goes into a printable state, the image formation apparatus prints the copies to be printed assigned to the external image formation apparatus. This enables efficient print output.

The print section may further perform the print operation of the unprinted copies of the external image formation apparatus when a situation under which the external image formation apparatus is capable of continuing the print operation has occurred during the print operation in the external image formation apparatus.

Even if a situation under which the external image formation apparatus cannot continue the print operation has occurred, the image formation apparatus prints copies not yet printed by the external image formation apparatus. This provides an operating environment which can flexibly cope with an abnormal situation.

In accordance with a fourth aspect of the present invention, the image formation apparatus connected to an external device and connected to an external image formation apparatus by a network, comprises:

a receiving section for receiving print information from the external device; and

a print information transfer section for transferring the print information received by the receiving section to the external image formation apparatus when printing by the external image formation apparatus is specified in the print information.

According to the fourth aspect of the present invention, the image formation apparatus has the function of transferring the print information to the external image formation apparatus connected to it by the network. This increases the usefulness of the image formation apparatus.

In accordance with a fifth aspect of the present invention, the image formation method comprises:

a receiving step for receiving print information from an external device;

a judgment step for judging from the print information received in the receiving step whether or not an assignment function for assigning printing to a main image formation apparatus which received the print information and a sub image formation apparatus is specified;

a communication connection step for performing a communication connection processing between the main image formation apparatus and the sub image formation apparatus when it is judged that the assignment function is specified in the judgment step;

a print step for performing print operation in the main image formation apparatus according to the received print information after the communication connection processing is performed in the communication connection step; and

a print information transfer step for transferring the received print information to the sub image formation apparatus after the communication connection processing is performed in the communication connection step.

The method may further comprise:

a release step for releasing the communication connection when the communication connection between the main image formation apparatus and the sub image formation apparatus is incapable according to the communication connection processing in the communication connection step, and

in the print step the main image formation apparatus may begin the print operation according to the print information received in the receiving step after the communication connection is released in the release step.

The method may further comprise:

an assignment step for assigning copies to be printed to each of the main image formation apparatus and the sub image formation apparatus on a basis of the print information received in the receiving step when the communication connection between the main image formation apparatus and the sub image formation apparatus is capable according to the communication connection processing in the communication connection step, and

in the print step the main image formation apparatus may perform the print operation of the copies to be printed assigned to the main image formation apparatus in the assignment step.

The print information may be transferred again to the sub image formation apparatus in the print information transfer step when the main image formation apparatus receives notice from the sub image formation apparatus that the sub image formation apparatus is in an unprintable state.

The method may further comprise:

a transfer step for transferring print data corresponding to the copies to be printed assigned to the sub image formation apparatus in the assignment step to the sub image formation apparatus on the basis of the print information received in the receiving step when the main image formation apparatus receives notice from the sub image formation apparatus that the sub image formation apparatus is in a printable state.

The method may further comprise:

a release step for releasing the communication connection between the main image formation apparatus and the sub image formation apparatus when the print operation of the copies to be printed assigned to the main image formation apparatus is completed in the print step before the sub image formation apparatus goes into a printable state, and

in the print step the main image formation apparatus may begin the print operation of the copies to be printed assigned to the sub image formation apparatus after the communication connection is released in the release step.

The main image formation apparatus may further perform the print operation of unprinted copies of the sub image formation apparatus in the print step when a situation under which the sub image formation apparatus is incapable of continuing the print operation has occurred during the print operation in the sub image formation apparatus.

The sub image formation apparatus may perform printing of unprinted copies of the main image formation apparatus when a situation under which the main image formation apparatus is incapable of performing the print operation in the print step has occurred.

In accordance with a sixth aspect of the present invention, the image formation method comprises:

a receiving step for receiving print information from an external device; and

a print information transfer step for transferring the print information received by a main image formation apparatus in the receiving step to a sub image formation apparatus when printing by the sub image formation apparatus is specified in the print information.

### BRIEF DESCRIPTION OF THE DRAWINGS

The present invention will be understood more fully from the detailed description given hereinafter and the accompanying drawings. However, these are not intended to limit the present invention, and wherein;

FIG. 1 is a view showing the entire structure of an image formation system to which the present invention is applied;

FIG. 2 is a block diagram showing the internal structure of a main image formation apparatus included in the image formation system shown in FIG. 1;

FIG. 3 is a sequence diagram showing an operation performed in the image formation system when carrying out tandem printing;

FIG. 4 is a sequence diagram showing an operation performed in the image formation system when the main image formation apparatus cannot make a communication connection with a sub image formation apparatus;

FIG. 5 is a sequence diagram showing a retry process performed in the image formation system when carrying out tandem printing;

FIG. 6 is a sequence diagram showing an operation performed in the image formation system when the main image formation apparatus completes printing during the retry process shown in FIG. 5;

FIGS. 7A and 7B are flow charts showing a tandem printing process performed by the main image formation apparatus;

FIG. 8 is a sequence diagram showing an operation performed when the main image formation apparatus transfers a print job to the sub image formation apparatus;

FIG. 9 is a sequence diagram showing an operation performed in the image formation system when memory overflow has occurred in the sub image formation apparatus;

FIG. 10 is a sequence diagram showing an operation performed when memory overflow which will not free a memory even after waiting has occurred in the main image formation apparatus; and

FIGS. 11A and 11B are sequence diagrams showing operation performed when memory overflow which will free the memory after waiting has occurred in the main image formation apparatus.

### DESCRIPTION OF THE PREFERRED EMBODIMENT

An embodiment of the present invention will now be described in detail with reference to the drawings.

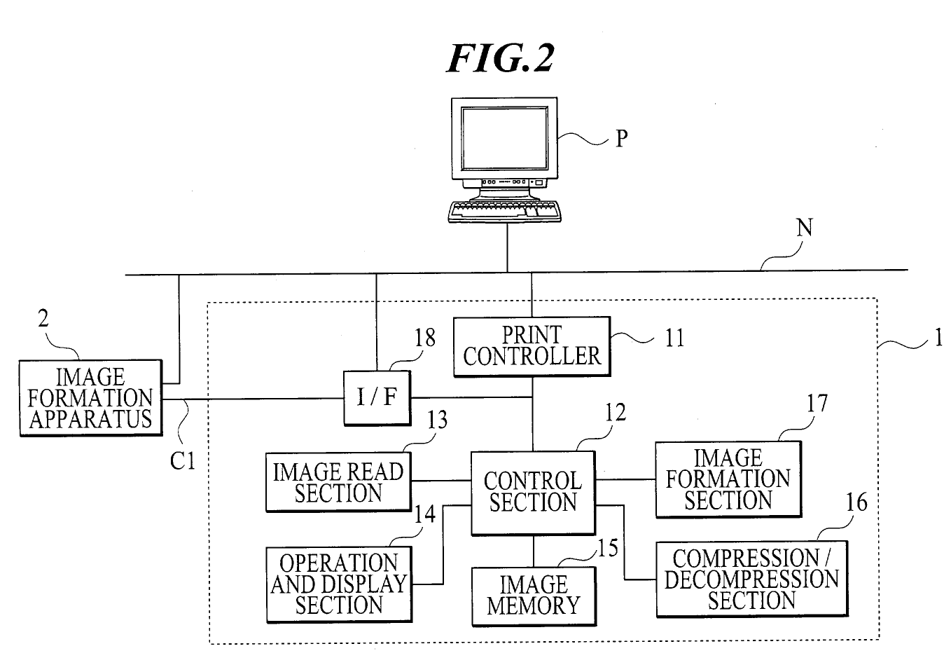

Here, the correspondence between a main image formation apparatus in an image formation system and an image formation apparatus 1 shown in FIG. 2 will be specified. In FIG. 2, a print controller 11, a control section 12, and an image formation section 17 function as a receiving section, a judgment section and assignment section, and a print section, respectively. Moreover, the control section 12, together with an I/F 18, functions as a communication connection section, communication connection release section, transfer section, and print information transfer section.

The structure of an image formation system according to the embodiment of the present invention will be described first.

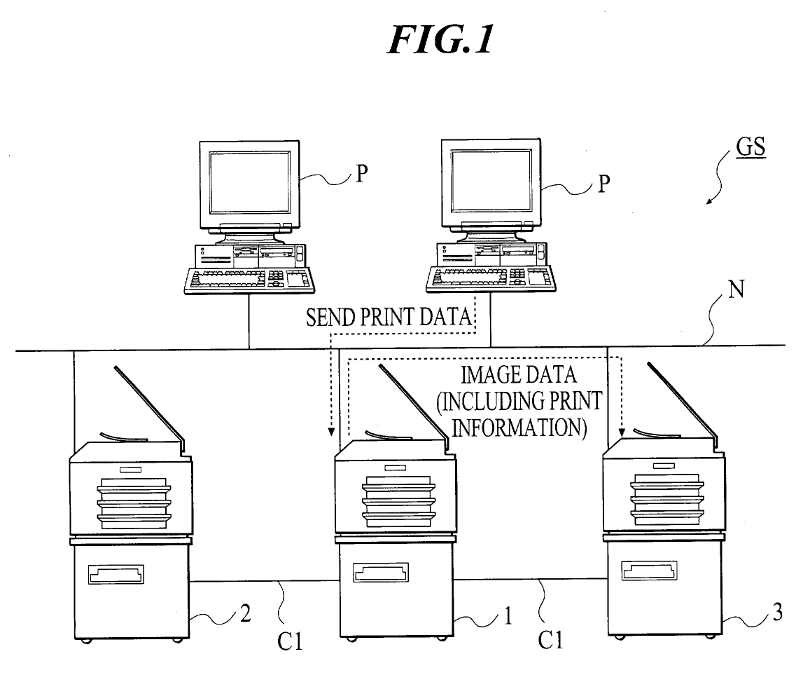

FIG. 1 is a view showing the entire structure of an image formation system GS according to the embodiment of the present invention. As shown in FIG. 1, the image formation system GS comprises external devices P and image formation apparatuses 1, 2 and 3. The external devices P are connected to the image formation apparatuses 1, 2 and 3 via a network N, such as a local area network (LAN) or the like. The image formation apparatuses 1, 2 and 3 are connected to one another via a hub (not shown) used on the network N, or cables C1.

In addition, the image formation system GS shown in FIG. 1 comprises two external devices P and three image formation apparatuses 1, 2 and 3. However, there is no special limitation on the number of external devices or image formation apparatuses. If at least one of a plurality of image formation apparatuses included in the image formation system GS includes a print controller (described later) for communicating with external devices P, then the present invention can be applied.

Hereinafter, it is assumed that the image formation apparatus 1 includes a print controller and that the image formation apparatuses 2 and 3 do not include a print controller. Hereinafter, the image formation apparatus 1 will be referred to as a main image formation apparatus 1, the image formation apparatus 2 will be referred to as a sub image formation apparatus 2, and the image formation apparatus 3 will be referred to as a sub image formation apparatus 3.

Next, each of sections included in the image formation system GS will be described.

Each external device P is a terminal, such as a personal computer or the like. A printer driver for controlling the main image formation apparatus 1 has been installed on each external device P.

FIG. 2 shows the structure of a feature of the main image formation apparatus 1. The main image formation apparatus 1 is a digital composite machine having the functions of a copying machine, a printer, a scanner and the like. As shown in FIG. 2, the main image formation apparatus 1 comprises a print controller 11, a control section 12, an image read section 13, an operation and display section 14, an image memory 15, a compression/decompression section 16, an image formation section 17, and an I/F section 18.

The print controller 11 comprises a central processing unit (CPU), an image memory, an I/F and the like. The CPU in the print controller 11 controls the operation of each section in the print controller 11 and exchanges data with an external device P connected to the network N. Moreover, the CPU stores print data received from the external device P in the image memory, and outputs it to the control section 12 described later. The image memory comprises a dynamic random access memory (DRAM). The image memory temporarily stores data received from the external device P via the network N. The I/F is an interface by which the main image formation apparatus 1 connects with the external device P via the network N.

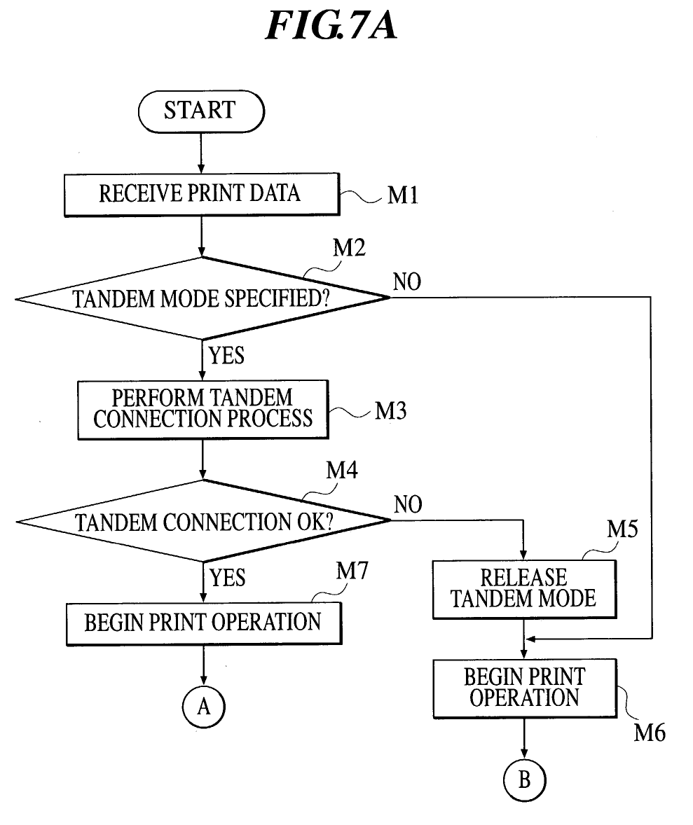

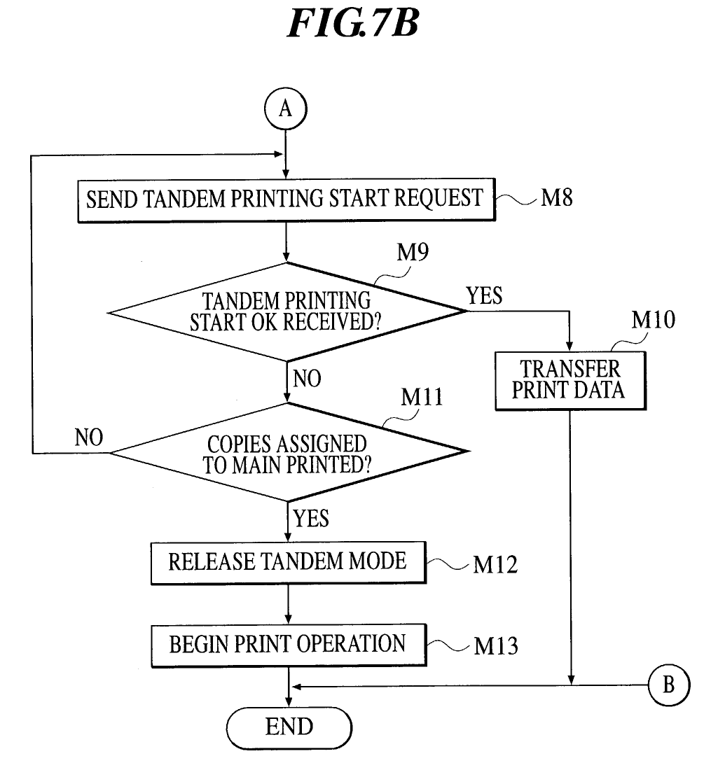

The control section 12 comprises a CPU, a read only memory (ROM) and the like. The CPU controls the operation of each section in the main image formation apparatus 1 in compliance with various control programs stored in the ROM. Moreover, in the present invention, the control section 12 controls print operation by the main image formation apparatus 1 according to print information inputted from the external device P via the print controller 11. In addition, in case that tandem mode is specified in the above-described inputted print information, the control section 12 performs a tandem printing process in which the main image formation apparatus 1 and a sub image formation apparatus connected thereto perform print operation at the same time (see FIGS. 7A and 7B). Here, the tandem mode means a function such that print information is exchanged via a network and print work is divided among a plurality of image formation apparatuses.

The image read section 13 has a scanner in a lower portion of contact glass for placing a manuscript thereon. The scanner comprises a light source, a lens, a charge-coupled device (CCD) and the like. The scanner reads an image on a manuscript by directing and scanning light from the light source to the manuscript, forming an image from reflected light, and performing a photoelectric conversion. Here, an image on a manuscript is not always image data, such as figures, photos or the like. It includes text data, such as letters, symbols or the like.

The operation and display section 14 includes a liquid crystal display (LCD) and the like. The operation and display section 14 performs necessary representation according to a display signal inputted from the control section 12. Moreover, the operation and display section 14 comprises a touch panel provided so as to cover a display screen, detects coordinates indicated by touching on the basis of a coordinate read principle, such as an electromagnetic induction method, a magnetostriction method, a pressure sensing method or the like, and outputs the detected coordinates to the control section 12 as a position signal. In addition, the operation and display section 14 comprises various operation keys, such as numeric keys, function keys for switching various settings, and the like, and outputs a signal generated by pressing a key to the control section 12.

The image memory 15 comprises a DRAM and has a page memory and a compression memory. The page memory temporarily stores one or two pages of image data inputted from the print controller 11 or one or two pages of image data decompressed by the compression/decompression section 16. The compression memory stores image data compressed by the compression/decompression section 16.

The compression/decompression section 16 compresses image data inputted from the image read section 13 or image data inputted from the page memory in the image memory 15. Moreover, the compression/decompression section 16 decompresses compressed image data inputted from the compression memory in the image memory 15.

The image formation section 17 comprises a laser diode (LD), a photosensitive drum, a toner, a paper feed section, an outputting section and the like. The image formation section 17 carries a sheet of printing paper the size and orientation of which are specified by inputted from the operation and display section 14 from the paper feed section according to a control signal sent from the control section 12, controls the driving of the LD by an image signal inputted from the control section 12, and forms an electrostatic latent image on the surface of the photosensitive drum. Moreover, the image formation section 17 makes the toner adhere to an area including the electrostatic latent image on the surface of the photosensitive drum, transcripts the toner onto the sheet of printing paper carried from the paper feed section, performs fixing, and thereafter, outputs the sheet of printing paper through the outputting section.

The I/F section 18 is an interface by which the main image formation apparatus 1 connects with other image formation apparatuses including the sub image formation apparatus 2 and 3 and the like via the hub (not shown) used on the network N, or the cables C1.

As stated above, the sub image formation apparatuses 2 and 3 shown in FIG. 1 are digital composite machines not including a print controller. The internal structure of the sub-image formation apparatuses 2 and 3 is the same as that of the main image formation apparatus 1 shown in FIG. 2 except that they do not include the print controller 11. In addition, the type of the sub image formation apparatuses 2 and 3 may differ from that of the main image formation apparatus 1.

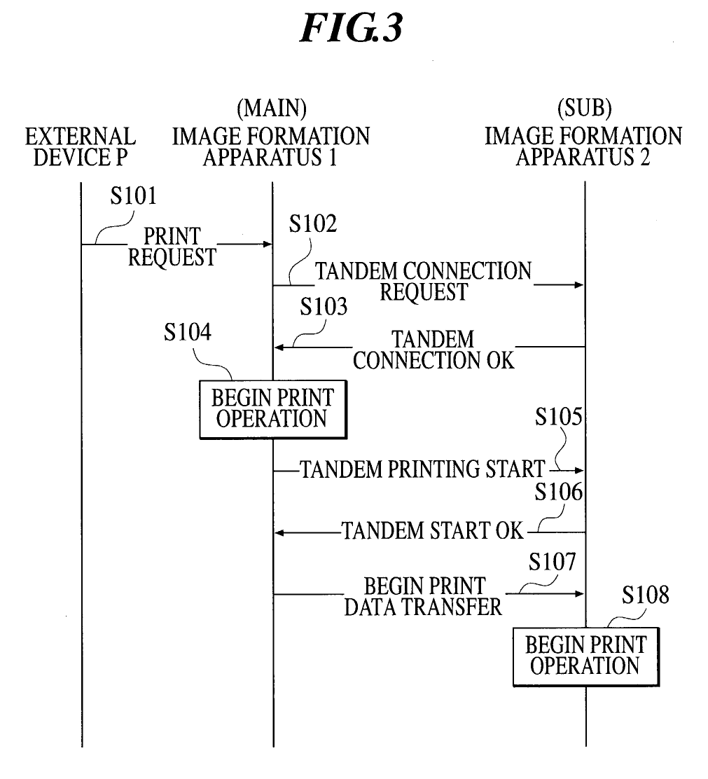

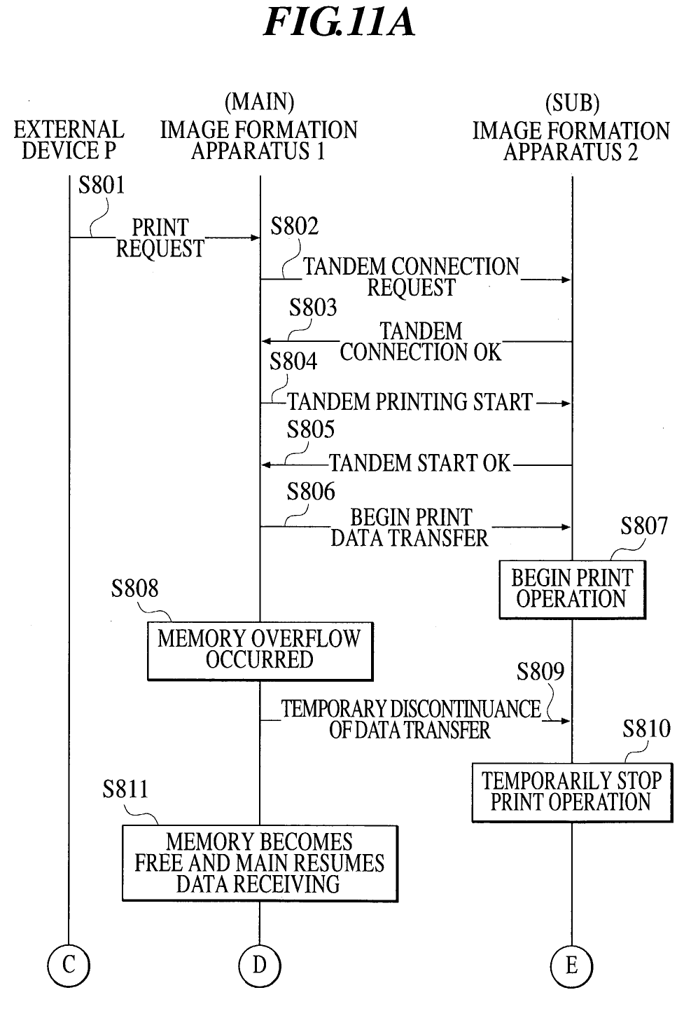

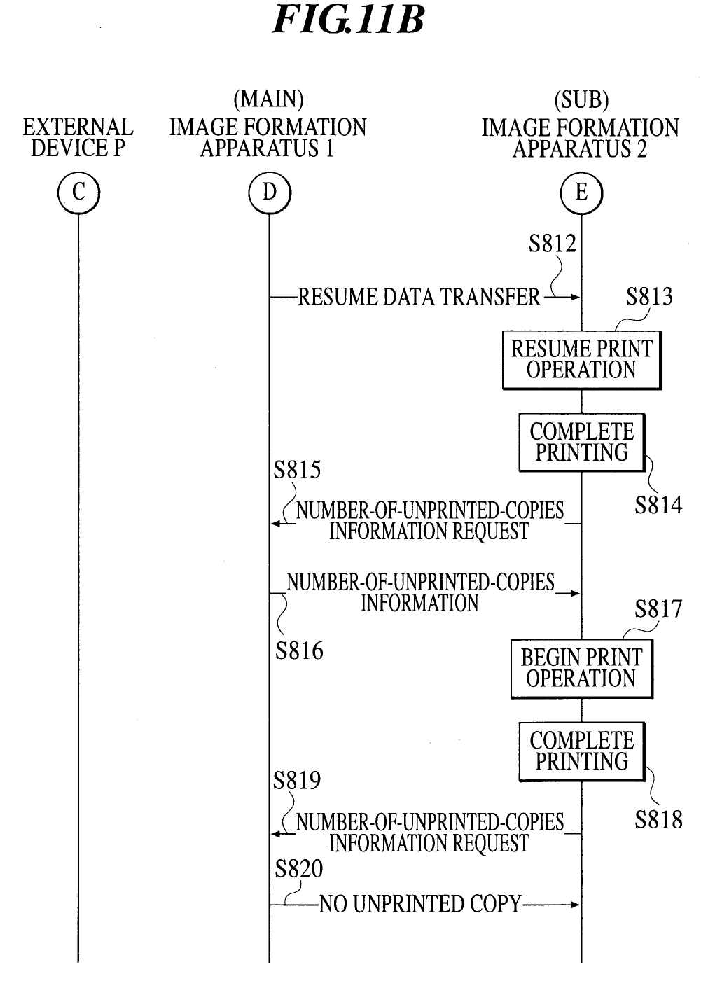

The sub image formation apparatuses 2 and 3 perform print operation on the basis of print data received from the main image formation apparatus 1 (see FIGS. 3, 5, and 8-11). For example, if an abnormality, such as memory overflow or the like, has occurred in the main image formation apparatus 1, the sub image formation apparatuses 2 and 3 will perform the print operation of printing copies to be printed assigned to the main image formation apparatus 1 (see FIGS. 11A and

Next, operation performed in this embodiment will be described.

Hereinafter, the main image formation apparatus 1 and the sub image formation apparatus 2 will be referred to as a main 1 and sub 2, respectively.

Operation performed in the image formation system GS when carrying out tandem printing will be described first with reference to a sequence diagram in FIG. 3.

First, tandem mode which gives instructions to do printing by the main 1 and sub 2 is specified on a print screen displayed by a printer driver on an external device P and the external device P sends a print request signal to the main 1 (step S101). The main 1 receives the print request signal from the external device P and judges from print information whether tandem mode is specified.

When the main 1 judges that tandem mode is specified, the main 1 sends the sub 2 a tandem communication connection request signal to make a communication connection with the sub 2 (step S102). When the main 1 receives a tandem connection OK signal from the sub 2 (step S103), the main 1 divides copies to be printed between the main 1 and sub 2, begins the print operation of the copies to be printed assigned to the main 1 (step S104), and sends the sub 2 a tandem printing start request signal (step S105).

When the main 1 receives a tandem printing start OK signal from the sub 2 (step S106), the main 1 starts to transfer print data corresponding to copies to be printed assigned to the sub 2 to the sub 2 (step S107). The sub 2 begins receiving the print data transferred from the main 1. When the conditions under which printing can be done are met, the sub 2 begins print operation (step S108). At the time when both the main 1 and sub 2 complete print operation, the main 1 releases a communication connection with the sub 2.

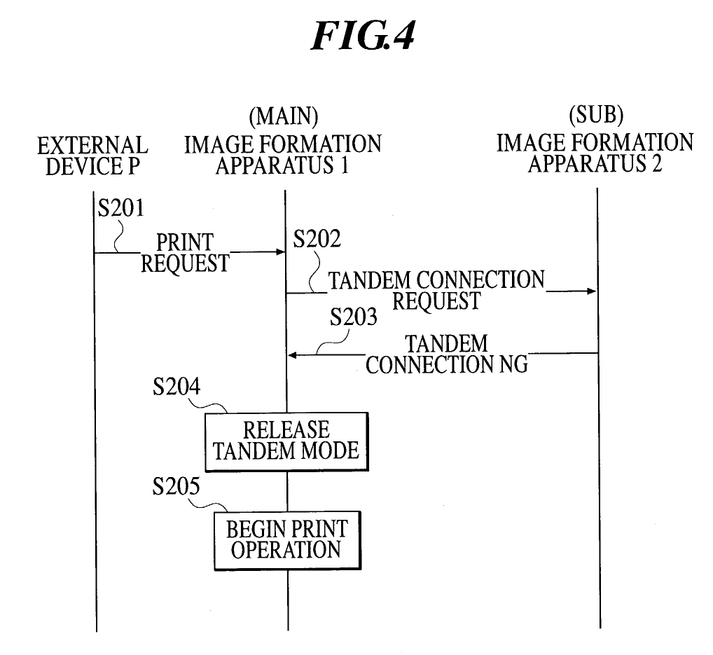

The operation performed in the image formation system GS when the main 1 cannot make a communication connection with the sub 2 will now be described with reference to a sequence diagram in FIG. 4.

First, tandem mode which gives instructions to do printing by the main 1 and sub 2 is specified on a print screen displayed by a printer driver on an external device P, and the external device P sends a print request signal to the main 1 (step S201). The main 1 receives the print request signal from the external device P and judges from print information whether tandem mode is specified.

When the main 1 judges that tandem mode is specified, the main 1 sends the sub 2 a tandem communication connection request signal (step S202). When the main 1 fails to make a communication connection with the sub 2 as a result of, for example, receiving a tandem connection NG signal from the sub 2 (step S203) or the occurrence of a communication error, the main 1 releases tandem mode by releasing a communication connection with the sub 2 (step S204), and begins print operation on the main 1 in normal mode (step S205). A communication error may occur, for example, when a cable for connecting the main 1 and sub 2 is not connected properly or is disconnected, when the power to the sub 2 is off, when a tandem environment is not set on the sub 2, or the like.

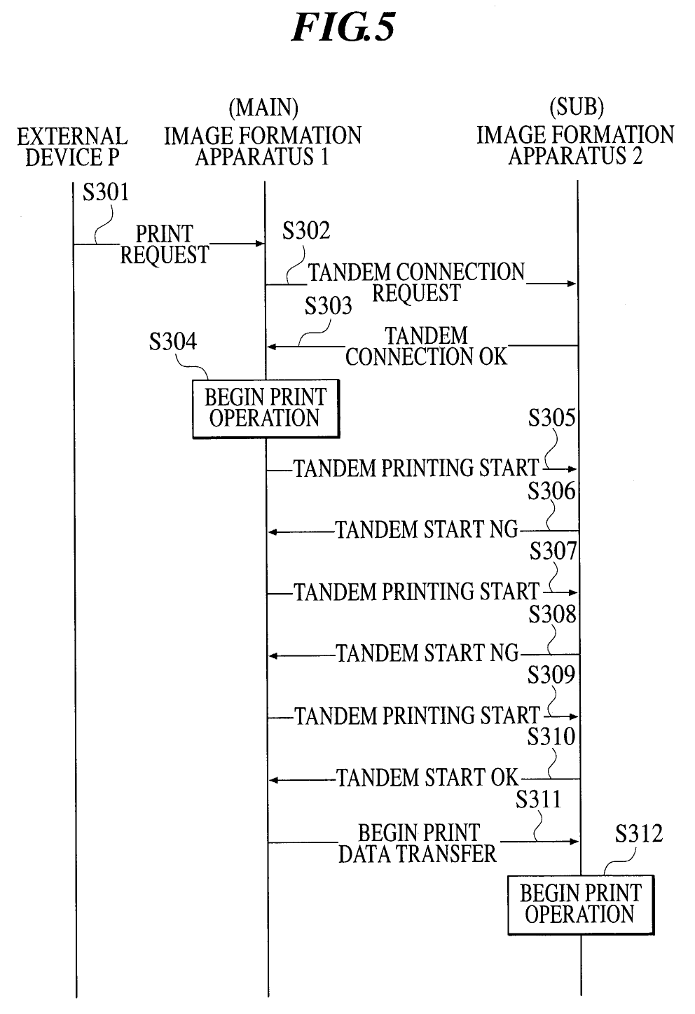

A retry process performed when carrying out tandem printing will now be described with reference to a sequence diagram in FIG. 5.

Steps S301 to S305 of the sequence diagram in FIG. 5 are the same as steps S101 to S105 of the sequence diagram in FIG. 3, so descriptions of them will be omitted.

After the main 1 begins print operation, the main 1 sends the sub 2 a tandem printing start request signal (step S305). If at this time the sub 2 is not in a state to add a job, the sub 2 will send the main 1 a tandem start NG signal (step S306). The main 1 which received the tandem start NG signal from the sub 2 sends the sub 2 a tandem printing start request signal again without sending the sub 2 print data (step S307). Until the sub 2 sends a tandem start OK signal, retry operation of steps S305 to S307 will be repeated (steps S308 and S309).

When the main 1 receives the tandem start OK signal from the sub 2 (step S310), the main 1 begins to transfer print data to the sub 2 (step S311). The sub 2 begins receiving the print data from the main 1. When the conditions under which printing can be done are met, the sub 2 begins print operation (step S312).

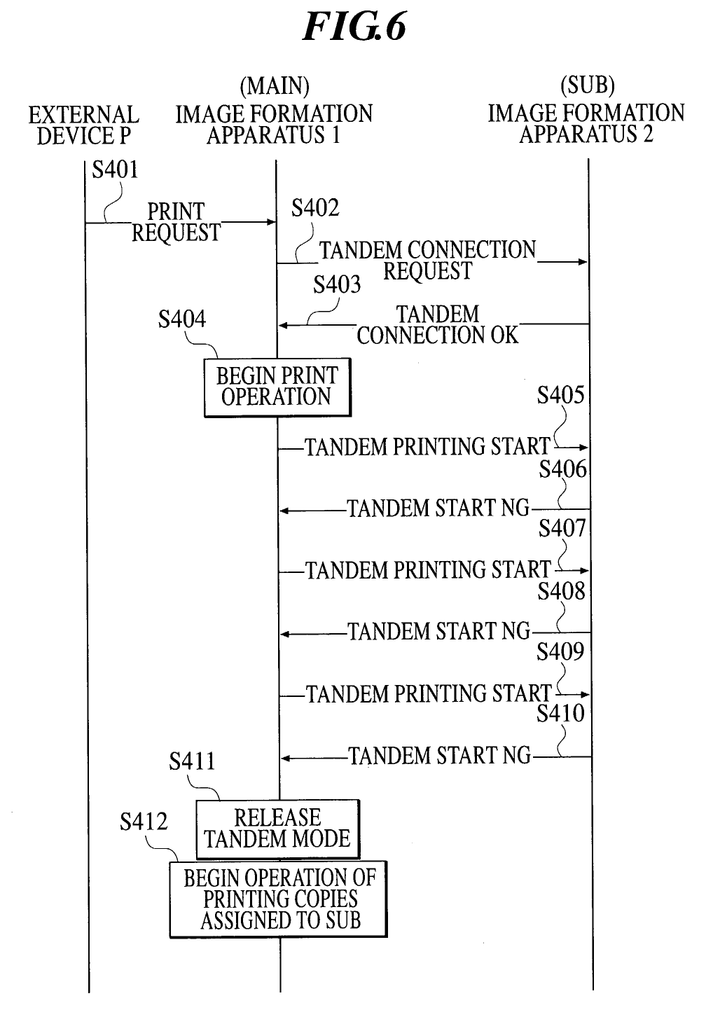

Operation performed in the image formation system GS when the main 1 completes printing during the retry process shown in FIG. 5 will now be described with reference to a sequence diagram in FIG. 6.

Steps S401 to S409 of the sequence diagram in FIG. 6 are the same as steps S301 to S309 of the sequence diagram in FIG. 5, so descriptions of them will be omitted.

The main 1 receives a tandem start NG signal from the sub 2 (step S410). If copies assigned to the main 1 has been printed before a tandem start OK signal being received, the main 1 releases tandem mode by releasing a communication connection with the sub 2 (step S411) and begins the print operation of the copies assigned to the sub 2 (step S412).

FIGS. 7A and 7B are flow charts which lump together the operation of the main 1 shown in FIGS. 3 to 6. A tandem printing process performed by the main 1 will now be described with reference to the flow charts in FIGS. 7A and 7B.

First, the print controller 11 receives print data from an external device P (step M1) and outputs it to the control section 12. The control section 12 judges from the print data inputted from the print controller 11 whether tandem mode is specified (step M2).

When in step M2 the control section 12 judges that tandem mode is not specified (“NO” in step M2), then the control section 12 outputs a control signal for giving instructions to perform normal print operation to the image formation section 17, and the image formation section 17 begins print operation according to the control signal sent from the control section 12 (step M6). When in step M2 the control section 12 judges that tandem mode is specified (“YES” in step M2), then the control section 12 sends an image formation apparatus with which the main 1 is instructed by the above-described print data to make a communication connection a tandem communication connection request signal via the I/F section 18 and performs the process of making a communication connection with the image formation apparatus (step M3). In this case, it is assumed that the main 1 makes a communication connection with the sub 2.

If the control section 12 receives a tandem connection NG signal from the sub 2 (“NO” in step M4) and therefore fails to make a communication connection with the sub 2, then the control section 12 makes the operation and display section 14 display the message “A tandem connection cannot be made. Tandem mode will be released.” and releases tandem mode (step M5). After the control section 12 releases tandem mode in step M5, the control section 12 gives the image formation section 17 instructions to begin normal print operation (step M6).

If the control section 12 receives a tandem connection OK signal from the sub 2 (“YES” in step M4) and therefore succeeds in making a communication connection with the sub 2, then the control section 12 divides copies to be printed between the main 1 and sub 2, gives the image formation section 17 instructions to perform the print operation of the copies to be printed assigned to the main 1 (step M7), and sends the sub 2 a tandem printing start request signal (step M8).

When the control section 12 receives a tandem printing start OK signal from the sub 2 (“YES” in step M9), then the control section 12 transfers print data corresponding to the copies to be printed assigned to the sub 2 to the sub 2 (step M10).

When the control section 12 receives a tandem printing start NG signal from the sub 2 (“NO” in step M9) and the print operation of the copies to be printed assigned to the main 1 is not completed (“NO” in step M11), then the control section 12 returns to step M8 to send the sub 2 a tandem printing start request signal again.

If the print operation of the copies to be printed assigned to the main 1 is completed before the control section 12 receives a tandem printing start OK signal from the sub 2 (“YES” in step M5), then the control section 12 releases tandem mode by releasing a communication connection (step M12) and gives the image formation section 17 instructions to begin the print operation of the copies to be printed assigned to the sub 2 (step M13).

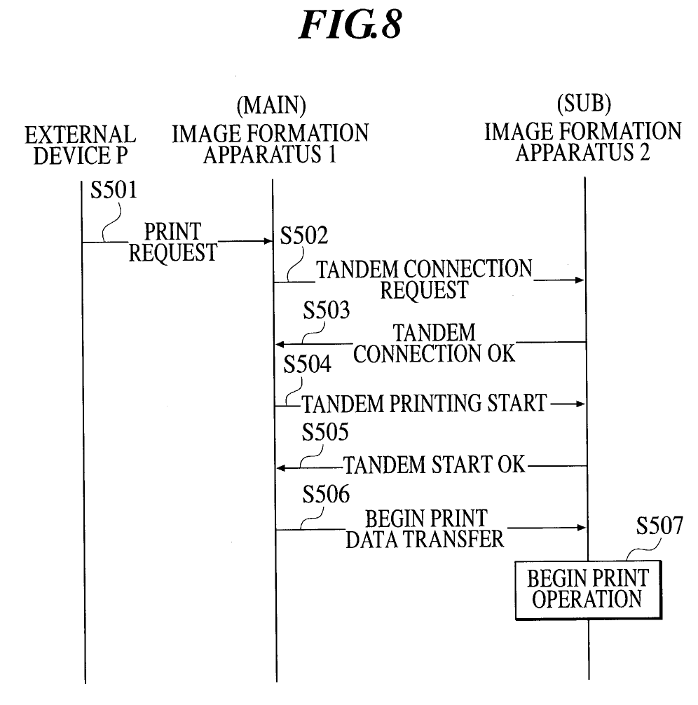

The operation performed in the image formation system GS when a print job is transferred to the sub 2 will now be described with reference to a sequence diagram in FIG. 8.

First, printing by the sub 2 is specified on a print screen displayed by a printer driver on an external device P, and the external device P sends a print request signal to the main 1 (step S501). The main 1 which received the print request signal judges from print information whether transfer only mode is specified.

When the main 1 judges that transfer only mode is specified in the print information, the main 1 sends the sub 2 a tandem communication connection request signal (step S502). When the main 1 receives a tandem connection OK signal from the sub 2 (step S503), the main 1 sends the sub 2 a printing start request signal (step S504).

When the main 1 receives a tandem start OK signal from the sub 2 (step S505), the main 1 begins to transfer print data to the sub 2 (step S506). The sub 2 begins receiving the print data. When the conditions under which printing can be done are met, the sub 2 begins print operation (step S507). When all the print data has been transferred, the main 1 releases a communication connection.

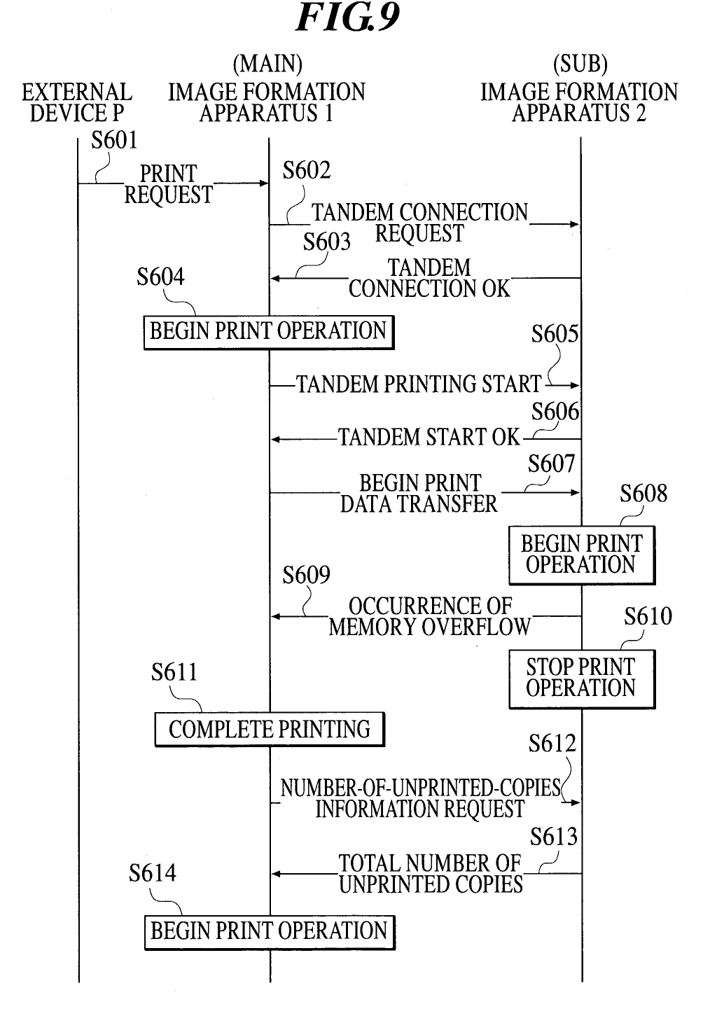

The operation performed when an abnormality has occurred in the image formation system GS will now be described with reference to FIGS. 9 to 11. Hereafter, the operation performed when memory overflow has occurred in the main 1 or the sub 2 will be described.

The operation performed in the image formation system GS when memory overflow has occurred in the sub 2 will be described first with reference to a sequence diagram in FIG. 9.

Steps S601 to S608 of the sequence diagram in FIG. 9 are the same as steps S101 to S108 of the sequence diagram in FIG. 3, so descriptions of them will be omitted.

When memory overflow occurs in the sub 2 during print operation by the sub 2, the sub 2 sends the main 1 a signal to inform about the memory overflow (step S609) and stops print operation (step S610).

When the main 1 completes the printing of copies assigned thereto (step S611), the main 1 sends the sub 2 a number-of-unprinted-copies information request signal (step S612). When the main 1 receives information regarding the number of copies not yet printed by the sub 2 from the sub 2 (step S613), the main 1 begins the print operation of the copies not yet printed by the sub 2 (step S614). After all copies are printed, the main 1 releases tandem mode by releasing a communication connection with the sub 2.

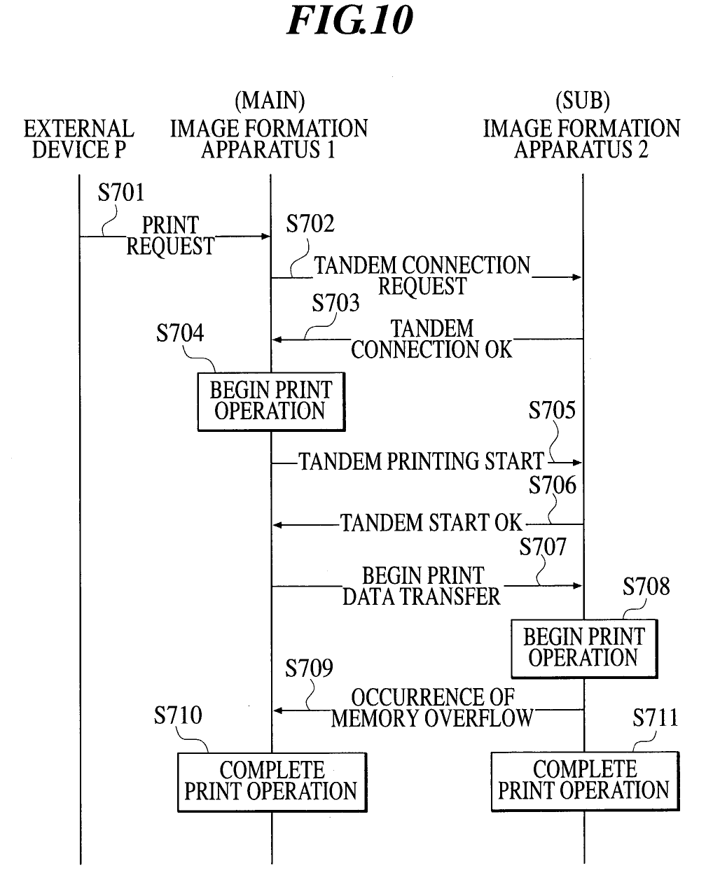

The operation performed when memory overflow which will not free the memory even after waiting has occurred in the main 1 will be described next with reference to a sequence diagram in FIG. 10. Here, the memory overflow which will not free the memory even after waiting means memory overflow occurred under conditions under which the memory used for another purpose is not expected to become free, such as where there is only one job, and the like.

Steps S701 to S708 of the sequence diagram in FIG. 10 are the same as steps S101 to S108 of the sequence diagram in FIG. 3, so descriptions of them will be omitted.

When memory overflow occurs during print operation by the main 1, the main 1 sends the sub 2 a signal to inform that memory overflow occurred (step S709) and completes print operation (step S710). The reason for completing the print operation is that the main 1 cannot receive data from an external device P under conditions under which the memory is not expected to become free. The sub 2 which is informed that the memory overflow occurred in the main 1 completes print operation (step S711) because receiving print data from the main 1 is stopped.

The operation performed when memory overflow which will free the memory after waiting has occurred in the main 1 will now be described with reference to sequence diagrams in FIGS. 11A and 11B. Here, memory overflow which will free the memory after waiting means the case such that memory overflow occurs in a state in which the main 1 has accepted a job reservation and the memory will become free as a result of the progress of the preceding job. In the following example, the case such that the main 1 is in a state unable to perform printing will be shown.

First, tandem mode is specified on a print screen displayed by a printer driver on an external device P, and the external device P sends a print request signal to the main 1 (step S801). The main 1 receives the print request signal sent from the external device P and judges from print information whether tandem mode is specified.

When the main 1 judges that tandem mode is specified, the main 1 sends the sub 2 a tandem communication connection request signal (step S802). When the main 1 receives a tandem connection OK signal from the sub 2 (step S803), the main 1 divides copies to be printed between the main 1 and sub 2 and sends the sub 2 a tandem printing start request signal (step S804).

When the main 1 receives a tandem printing start OK signal from the sub 2 (step S805), the main 1 begins to transfer print data corresponding to the copies to be printed assigned to the sub 2 to the sub 2 (step S806). The sub 2 begins receiving the print data transferred from the main 1. When the conditions under which printing can be done are met, the sub 2 begins print operation (step S807).

When memory overflow occurs in the main 1 (step S808), the main 1 sends the sub 2 a signal to inform about temporary interruption of the data transfer (step S809). The sub 2 temporarily stops print operation according to the signal received from the main 1 (step S810).

When the memory becomes free as a result of the progress of the preceding job, the main 1 resumes receiving data from the external device P (step S811) and resumes transferring the print data to the sub 2 (step S812). The sub 2 resumes receiving the print data transferred from the main 1 and resumes print operation (step S813).

When the sub 2 completes the printing of the copies to be printed assigned thereto (step S814), the sub 2 sends the main 1 a number-of-unprinted-copies information request signal (step S815). The main 1 sends the sub 2 number-of-unprinted-copies information in response to the number-of-unprinted-copies information request from the sub 2 (step S816).

The sub 2 begins print operation on the basis of the number-of-unprinted-copies information received from the main 1 (step S817). When the sub 2 completes the printing of the copies not yet printed (step S818), the sub 2 requests the main 1 again to send number-of-unprinted-copies information (step S819). If there is no unprinted copy, the main 1 sends the sub 2 a signal to inform that there is no unprinted copy (step S820), and releases tandem mode.

FIGS. 9 to 11 show operation performed when memory overflow occurs in the main 1 or sub 2 as an example of an abnormality. However, there are no special restrictions as to an abnormality. The present invention therefore is also applicable in a case where an abnormality, such as a paper failure, a paper jam or the like, has occurred. For example, when a paper failure has occurred in the sub 2, the main 1 can obtain number-of-unprinted-copies information from the sub 2, and can print copies not yet printed by the sub 2. This is the same as the operation shown in FIG. 9.

As has been described in the foregoing, with the image formation system GS according to the embodiment of the present invention, the main image formation apparatus 1 including the print controller 11 and the sub image formation apparatus are connected by the network N and the main image formation apparatus 1 controls print work divided between the main image formation apparatus 1 and the sub image formation apparatus on the basis of print information received from the external device P. This enables tandem printing by a plurality of image formation apparatuses without installing a print server (management server) as in earlier technology.

As stated above, the main image formation apparatus 1 including the print controller 11 has a function similar to that of a print server in the earlier technology and there is no need to install a print server in the image formation system GS. Therefore, a print server manager as in the earlier technology is unnecessary, resulting in a reduction in personnel expenses.

Moreover, there is no need to install a print server. Therefore, not all the image formation apparatuses included in the image formation system GS need to include a print controller. That is to say, at least one image formation apparatus (main image formation apparatus) should include a print controller. This enables print output from all of the image formation apparatuses connected to the main image formation apparatus by the network N, resulting in a reduction in the cost of the entire image formation system GS.

Furthermore, as shown in the sequence diagram in FIG. 6, when the printing of copies to be printed assigned to the main image formation apparatus 1 is completed before the sub image formation apparatus 2 going into a state capable of performing printing, the main image formation apparatus 1 will print the copies to be printed assigned to the sub image formation apparatus 2. This enables efficient print output.

In addition, as shown in the sequence diagram in FIG. 9, when a state, such as memory overflow or the like, under which the sub image formation apparatus 2 cannot continue print operation has arisen in the sub image formation apparatus 2, the main image formation apparatus 1 will automatically print the copies not yet printed by the sub image formation apparatus 2. This provides an operating environment which can flexibly cope with an abnormal situation.

Further, as shown in the sequence diagrams in FIGS. 11A and 11B, even if the main image formation apparatus 1 is in a state unable to perform printing, the sub image formation apparatus 2 connected to the main image formation apparatus 1 by the network N will automatically print the copies to be printed assigned to the main image formation apparatus 1. This provides an operating environment which can flexibly cope with abnormal condition. As stated above, even if an abnormality occurs in one image formation apparatus, the other image formation apparatus connected to it by the network N will cope with the situation. This enables efficient print output.

Although the present invention has been described according to the above embodiment, it should also be understood that the present invention is not limited to the above embodiment. Various changes and modifications may be made to the invention without departing from the gist thereof.

For example, in the above embodiment, when the main image formation apparatus 1 tries to make a communication connection with the sub image formation apparatus 2 and cannot do it, the main image formation apparatus 1 releases tandem mode and automatically performs print operation in normal mode. In this case, however, a function by which a user can select one of printing in normal mode or completing print operation may be included.

Furthermore, in the above embodiment, an example of performing tandem printing on the basis of print information received from the external device P is shown. For example, however, it is also possible to divide copies to be printed among the main image formation apparatus 1 and the sub image formation apparatuses 2 and 3, and to print image data read by the image read section 13 in the main image formation apparatus 1 by the main image formation apparatus 1 and the sub image formation apparatuses 2 and 3.

The entire contents, including the specification, claims, drawings, and abstract, of Japanese Patent Application No. 2002-172282 filed on Jun. 13, 2002 are incorporated herein by reference in its entirety.

What is claimed is:

1. An image formation system comprising:
a plurality of image formation apparatuses connected to a network, the plurality of the image formation apparatuses having at least one main image formation apparatus and at least one sub image formation apparatus,
the main image formation apparatus comprising:
a receiving section for receiving print information from a connected external device;
a judgment section for judging from the print information received by the receiving section whether or not an assignment function for assigning printing to the main image formation apparatus and the sub image formation apparatus is specified;
a communication connection section for performing a communication connection processing with the sub image formation apparatus when the judgment section judges that the assignment function is specified;
a print section for performing print operation in the main image formation apparatus according to the print information received by the receiving section after the communication connection processing by the communication connection section is performed; and
a print information transfer section for transferring the print information received by the receiving section to the sub image formation apparatus after the communication connection processing by the communication connection section is performed.

2. The system of claim 1, wherein the main image formation apparatus further comprises a release section for releasing the communication connection with the sub image formation apparatus when the communication connection with the sub image formation apparatus is incapable according to the communication connection processing by the communication connection section, and
the print section begins the print operation according to the print information received by the receiving section after the release section releases the communication connection.

3. The system of claim 1, wherein the main image formation apparatus further comprises an assignment section for assigning copies to be printed to each of the main image formation apparatus and the sub image formation apparatus on a basis of the print information received by the receiving section when the communication connection with the sub image formation apparatus is capable according to the communication connection processing by the communication connection section, and
the print section performs the print operation of the copies to be printed assigned to the main image formation apparatus by the assignment section.

4. The system of claim 1, wherein the print information transfer section transfers the print information again to the sub image formation apparatus when the main image formation apparatus receives notice from the sub image formation apparatus that the sub image formation apparatus is in an unprintable state.

5. The system of claim 3, wherein the main image formation apparatus further comprises a transfer section for transferring print data corresponding to the copies to be printed assigned to the sub image formation apparatus by the assignment section to the sub image formation apparatus on the basis of the print information received by the receiving section when the main image formation apparatus receives notice from the sub image formation apparatus that the sub image formation apparatus is in a printable state.

6. The system of claim 3, wherein the main image formation apparatus further comprises a release section for releasing the communication connection with the sub image formation apparatus when the print section completes the print operation of the copies to be printed assigned to the main image formation apparatus before the sub image formation apparatus goes into a printable state, and
the print section begins the print operation of the copies to be printed assigned to the sub image formation apparatus after the release section releases the communication connection.

7. The system of claim 3, wherein the print section in the main image formation apparatus further performs the print operation of unprinted copies of the sub image formation apparatus when a situation under which the sub image formation apparatus is incapable of continuing the print operation has occurred during the print operation in the sub image formation apparatus.

8. The system of claim 3, wherein the sub image formation apparatus performs printing of unprinted copies of the main image formation apparatus when a situation under which the print section in the main image formation apparatus is incapable of performing the print operation has occurred.

9. An image formation system comprising:
a plurality of image formation apparatuses connected to a network, the plurality of the image formation apparatuses having at least one main image formation apparatus and at least one sub image formation apparatus,
the main image formation apparatus comprising:
a receiving section for receiving print information from a connected external device; and
a print information transfer section for transferring the print information received by the receiving section to the sub image formation apparatus when printing by the sub image formation apparatus is specified in the print information.

10. An image formation apparatus connected to an external device and connected to an external image formation apparatus by a network, comprising:
a receiving section for receiving print information from the external device;
a judgment section for judging from the print information received by the receiving section whether or not an assignment function for assigning printing to the image formation apparatus and the external image formation apparatus is specified;
a communication connection section for performing a communication connection processing with the external image formation apparatus when the judgment section judges that the assignment function is specified;
a print section for performing print operation according to the print information received by the receiving section after the communication connection processing by the communication connection section is performed; and
a print information transfer section for transferring the print information received by the receiving section to the external image formation apparatus after the communication connection processing by the communication connection section is performed.

11. The image formation apparatus of claim 10, further comprising a release section for releasing the communication connection with the external image formation apparatus when the communication connection with the external image formation apparatus is incapable according to the communication connection processing by the communication connection section,
wherein the print section begins the print operation according to the print information received by the receiving section after the release section releases the communication connection.

12. The image formation apparatus of claim 10, further comprising an assignment section for assigning copies to be printed to each of the image formation apparatus and the external image formation apparatus on a basis of the print information received by the receiving section when the communication connection with the external image formation apparatus is capable according to the communication connection processing by the communication connection section,
wherein the print section performs the print operation of the copies to be printed assigned to the image formation apparatus by the assignment section.

13. The image formation apparatus of claim 10, wherein the print information transfer section transfers the print information again to the external image formation apparatus when the image formation apparatus receives notice from the external image formation apparatus that the external image formation apparatus is in an unprintable state.

14. The image formation apparatus of claim 12, further comprising a transfer section for transferring print data corresponding to the copies to be printed assigned to the external image formation apparatus by the assignment section to the external image formation apparatus on the basis of the print information received by the receiving section when the image formation apparatus receives notice from the external image formation apparatus that the external image formation apparatus is in a printable state.

15. The image formation apparatus of claim 12, further comprising a release section for releasing the communication connection with the external image formation apparatus when the print section completes the print operation of the copies to be printed assigned to the image formation apparatus before the external image formation apparatus goes into a printable state,
wherein the print section begins the print operation of the copies to be printed assigned to the external image formation apparatus after the release section releases the communication connection.

16. The image formation apparatus of claim 12, wherein the print section further performs the print operation of the unprinted copies of the external image formation apparatus when a situation under which the external image formation apparatus is capable of continuing the print operation has occurred during the print operation in the external image formation apparatus.

17. An image formation apparatus connected to an external device and connected to an external image formation apparatus by a network, comprising:
a receiving section for receiving print information from the external device; and
a print information transfer section for transferring the print information received by the receiving section to the external image formation apparatus when printing by the external image formation apparatus is specified in the print information.

18. An image formation method comprising:
a receiving step for receiving print information from an external device;
a judgment step for judging from the print information received in the receiving step whether or not an assignment function for assigning printing to a main image formation apparatus which received the print information and a sub image formation apparatus is specified;
a communication connection step for performing a communication connection processing between the main image formation apparatus and the sub image formation apparatus when it is judged that the assignment function is specified in the judgment step;
a print step for performing print operation in the main image formation apparatus according to the received print information after the communication connection processing is performed in the communication connection step; and
a print information transfer step for transferring the received print information to the sub image formation apparatus after the communication connection processing is performed in the communication connection step.

19. The method of claim 18, further comprising:
a release step for releasing the communication connection when the communication connection between the main image formation apparatus and the sub image formation apparatus is incapable according to the communication connection processing in the communication connection step,
wherein in the print step the main image formation apparatus begins the print operation according to the print information received in the receiving step after the communication connection is released in the release step.

20. The method of claim 18, further comprising:
an assignment step for assigning copies to be printed to each of the main image formation apparatus and the sub image formation apparatus on a basis of the print information received in the receiving step when the communication connection between the main image formation apparatus and the sub image formation apparatus is capable according to the communication connection processing in the communication connection step,
wherein in the print step the main image formation apparatus performs the print operation of the copies to be printed assigned to the main image formation apparatus in the assignment step.

21. The method of claim 18, wherein the print information is transferred again to the sub image formation apparatus in the print information transfer step when the main image formation apparatus receives notice from the sub image formation apparatus that the sub image formation apparatus is in an unprintable state.

22. The method of claim 20, further comprising:
a transfer step for transferring print data corresponding to the copies to be printed assigned to the sub image formation apparatus in the assignment step to the sub image formation apparatus on the basis of the print information received in the receiving step when the main image formation apparatus receives notice from the sub image formation apparatus that the sub image formation apparatus is in a printable state.

23. The method of claim 20, further comprising:
a release step for releasing the communication connection between the main image formation apparatus and the sub image formation apparatus when the print operation of the copies to be printed assigned to the main image formation apparatus is completed in the print step before the sub image formation apparatus goes into a printable state,
wherein in the print step the main image formation apparatus begins the print operation of the copies to be printed assigned to the sub image formation apparatus after the communication connection is released in the release step.

24. The method of claim 20, wherein the main image formation apparatus further performs the print operation of unprinted copies of the sub image formation apparatus in the print step when a situation under which the sub image formation apparatus is incapable of continuing the print operation has occurred during the print operation in the sub image formation apparatus.

25. The method of claim 20, wherein the sub image formation apparatus performs printing of unprinted copies of the main image formation apparatus when a situation under which the main image formation apparatus is incapable of performing the print operation in the print step has occurred.

26. An image formation method comprising:
a receiving step for receiving print information from an external device; and
a print information transfer step for transferring the print information received by a main image formation apparatus in the receiving step to a sub image formation apparatus when printing by the sub image formation apparatus is specified in the print information.
